(19) United States
(12) Patent Application Publication
(10) Pub. No.: US 2005/0203058 A1
(43) Pub. Date: Sep. 15, 2005

(54) Compositions of alpha- and beta-chitosan and methods of preparing them

(76) Inventor: Edwin Lee Johnson, Sammamish, WA (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/078,843

(22) Filed: Mar. 11, 2005

Related U.S. Application Data
(60) Provisional application No. 60/552,897, filed on Mar. 11, 2004.

(51) Int. Cl. C08B 37/08

(52) U.S. Cl. 514/55; 536/20

(57) ABSTRACT

The present invention relates to stable compositions comprising α- and β-chitosan and derivatives thereof for controlled absorption and/or coagulation of fluids from a wound or bleeding site. The invention further provides methods for preparing these stable compositions and articles of manufacture comprising these compositions. The stable compositions of the present invention are particularly useful in methods for treatment of open wounds or bleeding sites in a mammal using disposable medical and personal care articles that require controlled absorption, hemostasis, and tensile strength.

### CROSS-REFERENCE TO RELATED APPLICATION

This application claims benefit under 35 U.S.C. § 119(e) of U.S. provisional application No. 60/552,897, filed Mar. 11, 2004, the disclosure of which is herein incorporated by reference in its entirety.

### BACKGROUND OF THE INVENTION

Polymers used in wound dressings serve a number of different functions, including those related to biological function, such as hemostasis, prevention of bacterial and fungal growth, and biodegradability, and those related to materials function, such as fluid absorption and retention, and viscoelasticity.

Synthetic polyelectrolyte polymers are especially amenable to wound dressing applications since they may exhibit superabsorbent behavior due to their high molecular weights, crosslinked structure, and highly anionic and/or cationic nature. Specifically, repulsive forces between similarly charged groups contained on a single polymer chain may cause the chain to expand, attracting oppositely charged ions from the surrounding environment. This causes water or other fluids to enter and swell the polymer matrix in an attempt to reduce the osmotic pressure differential that exists between the high concentration of ions in the polymer matrix and the low concentration of ions in the surrounding environment. Additionally, a chemically-crosslinked polymer chain will maintain its integrity upon swelling while acting as a water- or fluid-insoluble matrix. It is this dichotomy, i.e., water-swellable but water-insoluble behavior, that makes synthetic polyelectrolyte polymers robust superabsorbent materials.

In addition to chemically-synthesized polymers, some naturally-derived polymers may also behave as superabsorbent materials. Although natural polymers may be advantageous as wound dressings because they are non-toxic, biocompatible, and biodegradable, their commercial application may be limited because they typically possess properties that are inferior to synthetic polymers. An added complication is that some natural polymers may not be readily derived from abundant renewable biological sources.

A particularly useful superabsorbent biopolymer that does not suffer from these limitations is chitosan, a derivative of chitin, a naturally-occurring high molecular weight linear polymer of N-acetyl-D-glucosamine having the following formula, where n represents the degree of polymerization:

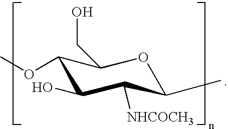

Chitin and its derivatives are the second most common polysaccharide found on earth (cellulose being first) with approximately 10 billion tons of it annually produced in living organisms (U.S. Pat. No. 6,444,797). In addition to its natural abundance, chitin is a highly crystalline material that is resistant to solubilization in many solvents as a result of its intermolecular bonding through its aminoacetyl groups (U.S. Pat. No. 5,322,935). Moreover, chitin exists as either α-chitin or β-chitin, depending on whether the linkage between glucosamine units is alpha- or beta-, respectively, and resides most abundantly in crustaceans, insects, fungi, algae and yeasts. For example, α-chitin is obtained predominantly from the shells of crustaceans, e.g., lobster, crab, and shrimp, whereas β-chitin is derived from squid pens. However, because the intermolecular forces of β-chitin are weaker than those in α-chitin, β-chitosan is more soluble, reactive, and absorptive than α-chitosan.

Chitin may be converted to its soluble derivative, chitosan, by N-deacetylation. Moreover, the solubility of chitosan depends on the degree of deacetylation. Chitosan is illustrated as follows: 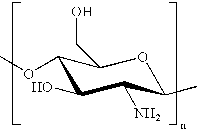
where n is the degree of polymerization. Commercially-available chitosan is produced with a degree of deacetylation typically ranging from between 70 and 100% but can be produced to have a degree of deacetylation as low as 50% (U.S. Pat. No. 5,621,088). It is the reaction of the primary amino group of the deacetylated chitosan with various inorganic and organic acids that leads to partial disruption of the hydrogen bonds within its structure, causing swelling and eventual dissolution. (Dutkiewicz, Journal of Biomedical Materials Research Applied Biomaterials, 63, 3, 373-381 (2002)).

The use of chitosan as a material for wound healing is known. For example, U.S. Pat. No. 5,836,970 discloses chitosan and alginate wound dressings that may be prepared as fibers, powders, flexible films, foams, or water-swellable hydrocolloids. Likewise, U.S. Pat. No. 5,599,916 discloses a water-swellable, water-insoluble chitosan salt that may be used in wound dressings, and U.S. Pat. No. 6,444,797 discloses a chitosan microflake that may be used as a wound dressing or skin coating.

It is desirable to develop new and improved compositions comprising α- and β-chitosan and derivatives thereof and methods of making such compositions as superabsorbent materials in personal- and wound-care management.

### SUMMARY OF THE INVENTION

The present invention provides stable compositions comprising α- and β-chitosan and derivatives thereof for controlled absorption and/or coagulation of fluids from open wounds or bleeding sites in a mammal and provides methods for preparing these compositions. Methods of use of these stable compositions are also provided herein.

The compositions and methods according to this invention are especially useful as articles for wound dressings and personal care, where stability (shelf-life) and controlled absorption and/or coagulation are critical. For example, α- or β-chitosan pads prepared according to this invention can be stored as stable, dry pads having various shapes and thicknesses. Once applied to a wound area, the dry chitosan pad may act as both a fluid absorbent and a blood coagulant while expanding differentially to meet the contour of the wound and the amount of blood and other fluids present. Thus, wound dressings having varying absorbencies and hemostatic activities may be produced using the methods provided herein.

One aspect of the invention relates to a substantially water-insoluble composition comprising α- or β-chitosan and a non-volatile organic acid, wherein the chitosan forms a salt with a selected amount of the non-volatile organic acid. In certain embodiments, the composition absorbs a predetermined amount of a fluid selected from water, serum, blood, saline, and mixtures thereof. In certain embodiments, the composition further comprises a residual amount of a volatile organic acid. In certain embodiments, the substantially water-insoluble composition functions as a hemostat.

Another aspect of the invention relates to a substantially water-insoluble composition comprising chitosan and a non-volatile organic acid, the chitosan forming a chitosan salt with the non-volatile organic acid wherein the chitosan salt is produced by (a) mixing an amount of chitosan with an amount of organic acid and water to produce a dissolved chitosan salt mixture, wherein the ratio of moles organic acid/moles chitosan is equal to or greater than one, the organic acid comprises a non-volatile organic acid and a volatile organic acid, the ratio of moles of non-volatile organic acid/moles chitosan is less than one, and the moles of volatile organic acid/moles chitosan is less than one; (b) freeze-drying the chitosan salt mixture, wherein a portion of the volatile organic acid is sublimed with the water; and (c) reducing the amount of remaining volatile organic acid to obtain the substantially water-insoluble composition. In certain embodiments, the substantially water-insoluble composition absorbs a predetermined amount of fluid selected from water, serum, blood, saline, and mixtures thereof. In certain alternative embodiments, the substantially water-insoluble composition functions as a hemostat.

Another aspect of the invention relates to methods for making a substantially water-insoluble composition comprising chitosan and a non-volatile organic acid, the chitosan forming a chitosan salt with the non-volatile organic acid, the method comprising (a) mixing an amount of chitosan with an amount of organic acid and water to produce a dissolved chitosan salt mixture, wherein the ratio of moles organic acid/moles chitosan is equal to or greater than one, the organic acid comprises a non-volatile organic acid and a volatile organic acid, the ratio of moles of non-volatile organic acid/moles chitosan is less than one, and the moles of volatile organic acid/moles chitosan is less than one, (b) freeze-drying the chitosan salt mixture, wherein a portion of the volatile organic acid is sublimed with the water, and (c) reducing the amount of remaining volatile organic acid to obtain the substantially water-insoluble composition. In certain embodiments, the substantially water-insoluble composition absorbs a predetermined amount of fluid selected from water, serum, blood, saline, and mixtures thereof. In certain alternative embodiments, the substantially water-insoluble composition functions as a hemostat.

### BRIEF DESCRIPTION OF THE DRAWINGS

The above and other advantages of the invention will be apparent upon consideration of the following detailed description, taken in conjunction with the accompanying drawings, in which:

FIG. 1 illustrates the moles of acetic acid per mole of chitosan remaining in chitosan pad after heating at 60° C. for 0, 1, 2, 3, 4 and 25 hours (see Example 1);

FIG. 2A illustrates the effect of heating at 60° C. for various times on water absorption in the chitosan-acetate pad (see Example 1);

FIG. 2B shows the effect of acetic acid on water absorption in the chitosan-acetate pad (see Example 1);

FIG. 3 illustrates the reduction of acetic acid in the chitosan pad after heating at 60° C. for 0, 1, 2, 4, 6, 10 and 14 hours (see Example 7);

FIG. 4 illustrates the molar amounts of chitosan, succinic acid and acetic acid per kilogram solids after 0, 1, 2, 4, 6, 10 and 14 hours of heating at 60° C. (see Example 9);

FIG. 5 illustrates the moles of mixed acid (volatile and non-volatile organic acids) per kilogram solids divided by the moles of chitosan per kilogram solids versus 0.15 M saline absorption after annealing the chitosan pads at 60° C. for 0, 1, 2 and 4 hours (see Example 9); and

FIG. 6 illustrates saline absorption of chitosan-succinate pads versus moles of volatile acid lost (see Example 9).

FIG. 7 illustrates the relationship between bulk elastic modulus, swollen volume and moles of volatile anion lost of chitosan according to equation 19 (see Example 16).

### DETAILED DESCRIPTION OF THE INVENTION

The present invention is based on the discovery that the method for preparing salts of α- and β-chitosan and derivatives thereof is essential to forming new and stable α- and β-chitosan compositions having controlled absorption, hemostasis and tensile strength for use in wound management or personal-care products. More particularly, the ratio of non-volatile organic acid to volatile organic acid, as well as the ratio of mixed acid (non-volatile and volatile organic acids) to chitosan, during the process of preparing a substantially water-insoluble chitosan composition determines absorption, hemostasis, and tensile strength.

In certain embodiments, the invention relates to a substantially water-insoluble composition comprising α- or β-chitosan and a non-volatile organic acid, wherein the chitosan forms a salt with a selected amount of the non-volatile organic acid. In certain embodiments, the invention relates to a substantially water-insoluble composition comprising α- or β-chitosan and a non-volatile organic acid, wherein the chitosan forms a salt with a selected amount of the non-volatile organic acid such that said composition absorbs a predetermined amount of a fluid selected from water, serum, blood, saline, and mixtures thereof.

In certain embodiments, the substantially water-insoluble composition further comprises a component selected from water, volatile organic acid, growth factors, antibiotics, and mixtures thereof. In certain such embodiments, the substantially water-insoluble composition comprises α- or β-chitosan, a non-volatile organic acid, and a residual amount of a volatile organic acid. Preferably the volatile organic acid is present in the composition at a concentration selected from less than 5% by weight of total solids, less than 2% by weight, and less than 1% by weight of total solids. In certain such embodiments, although not meant to be limiting, the volatile organic acid is selected from acetic acid, acrylic acid, iso-butyric acid, n-butyric acid, formic acid, propionic acid, pyruvic acid, and mixtures thereof. Preferably, the volatile organic acid is acetic acid.

In certain embodiments, the composition comprising α- or β-chitosan has a weight-average molecular weight of between about 50,000 and about 2,000,000 and a degree of deacetylation of between about 60% and 100%. In certain preferred such embodiments, the degree of deacetylation is at least 70%, more preferably at least 80%, yet more preferably at least 90%. In certain preferred such embodiments, the degree of deacetylation is at least 95%. In certain preferred such embodiments, the degree of deacetylation is at least 99%.

In accordance with this invention, the non-volatile organic acid and the α- or β-chitosan are present in the above-identified substantially water-insoluble composition at a mole ratio of non-volatile acid/chitosan of between about 0.2 to about 0.99, about 0.2 to about 0.85, about 0.2 to about 0.8, or about 0.2 to about 0.6. In certain preferred embodiments, the mole ratio of non-volatile acid/chitosan is between about 0.4 and about 0.95, about 0.4 to about 0.85, or about 0.4 to about 0.8. In an alternate embodiment, the mole ratio of non-volatile acid/chitosan is between about 0.95 and about 0.99. Preferably, the non-volatile organic acid is a polyprotic acid that has a melting point greater than 125° C. Non-volatile organic acids include, but are not limited to, adipic acid, ascorbic acid, citric acid, fumaric acid, glutamic acid, iminodiacetic acid, itaconic acid, lactic acid, maleic acid, malic acid, nitriloacetic acid, 2-pyrrolidone-5-carboxysol, succinic acid, tartaric acid and mixtures thereof. In certain embodiments, the non-volatile organic acids include, but are not limited to, adipic acid, fumaric acid, glutamic acid, iminodiacetic acid, itaconic acid, maleic acid, malic acid, nitriloacetic acid, 2-pyrrolidone-5-carboxysol, succinic acid, tartaric acid. In certain preferred embodiments, the non-volatile organic acid is succinic acid.

The presence of the non-volatile organic acid in the substantially water-insoluble composition comprising α- or β-chitosan provides stability during storage. More particularly, if only a volatile acid is used to produce a chitosan salt mixture, the volatile acid evaporates over time during storage, which may cause a reduction in absorption properties of the composition over time, therefore, the vapor pressure of the acid at the storage temperature is important.

The use of chitosan to achieve hemostasis, inhibit fibroplasias, and promote tissue regeneration is known (e.g., see U.S. Pat. Nos. 4,394,373 and 4,532,134). Accordingly, the substantially water-insoluble composition comprising α- or β-chitosan also functions as a hemostat.

In addition to controlled absorption and hemostasis, the compositions according to this invention may also be prepared to have specific ranges of tensile strengths. Preferably, the substantially water-insoluble composition comprising α- or β-chitosan has a specific tensile strength.

Additionally, this invention provides a method for treatment of open wounds or bleeding sites in a mammal using disposable medical and personal care articles comprising the compositions described herein. This method of treating a mammal having an open wound or bleeding site, comprises applying td said mammal a substantially water-insoluble composition comprising α- or β-chitosan and a non-volatile organic acid, wherein the chitosan forms a salt with the non-volatile organic acid such that the composition absorbs a predetermined amount of a fluid selected from water, serum, blood, saline, and mixtures thereof. This composition may further comprise a residual amount of volatile organic acid that is present in the composition at a concentration selected from less than 5% by weight of total solids, less than 2% by weight of total solids and less than 1% by weight of total solids.

In accordance with this invention, the non-volatile organic acid and the α- or β-chitosan are present in the above-identified substantially water-insoluble composition at a mole ratio of non-volatile acid/chitosan of between about 0.2 to about 0.99, about 0.2 to about 0.85, about 0.2 to about 0.8, or about 0.2 to about 0.6. In certain preferred embodiments, the mole ratio of non-volatile acid/chitosan is between about 0.4 and about 0.95, about 0.4 to about 0.85, or about 0.4 to about 0.8. In an alternate embodiment, the mole ratio of non-volatile acid/chitosan is between about 0.95 and about 0.99. Preferably, the non-volatile organic acid is a polyprotic acid that has a melting point greater than 125° C. Non-volatile organic acids include, but are not limited to, adipic acid, ascorbic acid, citric acid, fumaric acid, glutamic acid, iminodiacetic acid, itaconic acid, lactic acid, maleic acid, malic acid, nitriloacetic acid, 2-pyrrolidone-5-carboxysol, succinic acid, tartaric acid, and mixtures thereof. In certain embodiments, the non-volatile organic acid is selected from adipic acid, fumaric acid, glutamic acid, iminodiacetic acid, itaconic acid, maleic acid, malic acid, nitriloacetic acid, 2-pyrrolidone-5-carboxysol, succinic acid, tartaric acid, and mixtures thereof. In certain preferred embodiments, the non-volatile organic acid is succinic acid.

Another aspect of this invention relates to the substantially water-insoluble composition comprising α- or β-chitosan and a non-volatile organic acid, wherein the chitosan forms a chitosan salt with the non-volatile organic acid, and the composition is produced by a method comprising (a) mixing an amount of chitosan with an amount of organic acid and water to produce a dissolved chitosan salt mixture, wherein the ratio of moles organic acid/moles chitosan is equal to or greater than one, the organic acid comprises a non-volatile organic acid and a volatile organic acid, the ratio of moles of non-volatile organic acid/moles chitosan is less than one, and the moles of volatile organic acid/moles chitosan is less than one, (b) freeze-drying the chitosan salt mixture, wherein a portion of the volatile organic acid is sublimed with the water, and (c) reducing the amount of remaining volatile organic acid to obtain the substantially water-insoluble composition. Reducing the amount of remaining volatile organic acid may be accomplished by any one of solvent extraction, heating, vacuum drying, or air drying the chitosan salt mixture.

In certain embodiments, the amount of remaining volatile acid is reduced by heating. In one embodiment of this invention, the composition is heated to less than 60° C. In an alternate embodiment, the composition is heated to less than 50° C.

In certain embodiments, the substantially water-insoluble composition made as described above absorbs a predetermined amount of fluid selected from water, serum, blood, saline, and mixtures thereof. In an alternative embodiment, the substantially water-insoluble composition made as described above functions as a hemostat. In certain embodiments, the substantially water-insoluble composition has a specific tensile strength.

In certain embodiments, the non-volatile organic acid in the substantially water-insoluble composition made by the above-described method has a melting point of greater than 125° C. In certain such embodiments, the non-volatile organic acid is selected from adipic acid, ascorbic acid, citric acid, fumaric acid, glutamic acid, iminodiacetic acid, itaconic acid, lactic acid, maleic acid, malic acid, nitriloacetic acid, 2-pyrrolidone-5-carboxysol, succinic acid, tartaric acid, and mixtures thereof. In certain preferred such embodiments, the non-volatile organic acid is selected from adipic acid, fumaric acid, glutamic acid, iminodiacetic acid, itaconic acid, maleic acid, malic acid, nitriloacetic acid, 2-pyrrolidone-5-carboxysol, succinic acid, tartaric acid, and mixtures thereof. In certain preferred such embodiments, the volatile organic acid is selected from acetic acid, acrylic acid, butyric acid, formic acid, propionic acid, pyruvic acid, and mixtures thereof.

In certain preferred embodiments, the non-volatile organic acid and the α- or β-chitosan are present in the substantially water-insoluble composition made according to the method above at a mole ratio of non-volatile acid/chitosan of between about 0.2 to about 0.99, about 0.2 to about 0.85, about 0.2 to about 0.80, or about 0.2 to about 0.6. In certain preferred such embodiments, the mole ratio of non-volatile acid/chitosan is between about 0.4 and about 0.95, about 0.4 to about 0.85, or about 0.4 to about 0.8. In an alternate embodiment, the mole ratio of non-volatile acid/chitosan is between about 0.95 and about 0.99. In certain embodiments, the volatile organic acid in the substantially water-insoluble composition is present at a concentration selected from less than 5% by weight of total solids, less than 2% by weight of total solids, and less than 1% by weight of total solids.

The compositions and methods according to this invention are especially useful as articles for wound dressings and personal care, where controlled absorption, hemostatic activities and tensile strengths are desired. For example, α- or β-chitosan pads made according to this invention can be stored as dry pads having various shapes and thicknesses. Once applied to a wound area, the dry chitosan pad may act as both a fluid absorbent and a blood coagulant while expanding differentially to meet the contour of the wound and the amount of fluid present. In certain preferred embodiments, the dry chitosan strip pads have a gel time of around 30 seconds when applied to a mammal, regardless of the mammal's blood factor. In another embodiment, heparin may be added to the chitosan strip pad.

Another aspect of the invention relates to an article of manufacture comprising the substantially water-insoluble composition comprising α- or β-chitosan. Accordingly, the article of manufacture is selected from an absorbent pad, a bandage, a diaper, and a feminine hygiene absorbent article. In certain preferred embodiments, the substantially water-insoluble composition is in the form of a pad, a film, a sponge, a sheet, a flake, or a powder.

Also provided is a method for making a porous, substantially water-insoluble composition comprising α- or β-chitosan and a non-volatile organic acid, wherein the chitosan forms a chitosan salt with the non-volatile organic acid, wherein the method comprises (a) mixing an amount of chitosan with an amount of organic acid and water to produce a dissolved chitosan salt mixture, wherein the ratio of moles organic acid/moles chitosan is equal to or greater than one, the organic acid comprises a non-volatile organic acid and a volatile organic acid, the ratio of moles of non-volatile organic acid/moles chitosan is less than one, and the moles of volatile organic acid/moles chitosan is less than one, (b) freeze-drying the chitosan salt mixture, wherein a portion of the volatile organic acid is sublimed with the water, and (c) reducing the amount of remaining volatile organic acid to obtain the substantially water-insoluble composition. Reducing the amount of remaining volatile organic acid to obtain the substantially water-insoluble composition may be accomplished by any one of solvent extraction, heating, vacuum drying, and air drying the chitosan salt mixture.

In certain embodiments, the amount of remaining volatile acid is reduced by heating. In one embodiment of this invention, the composition is heated to less than 60° C. In an alternate embodiment, the composition is heated to less than 50° C.

In certain embodiments, the substantially water-insoluble composition absorbs a predetermined amount of fluid selected from water, serum, blood, saline, and mixtures thereof. In certain alternative embodiments, the substantially water-insoluble composition made according to the above-described method functions as a hemostat. In certain embodiments, the substantially water-insoluble composition made according to the above-described method has a specific tensile strength.

In certain embodiments, the non-volatile organic acid in the above-described method has a melting point of greater than 125° C. In certain embodiments, the non-volatile organic acid is selected from adipic acid, ascorbic acid, citric acid, fumaric acid, glutamic acid, iminodiacetic acid, itaconic acid, lactic acid, maleic acid, malic acid, nitriloacetic acid, 2-pyrrolidone-5-carboxysol, succinic acid, tartaric acid, and mixtures thereof. In certain such embodiments, the non-volatile organic acid is selected from adipic acid, fumaric acid, glutamic acid, iminodiacetic acid, itaconic acid, maleic acid, malic acid, nitriloacetic acid, 2-pyrrolidone-5-carboxysol, succinic acid, tartaric acid, and mixtures thereof. In certain embodiments, the volatile organic acid is selected from acetic acid, acrylic acid, butyric acid, formic acid, propionic acid, pyruvic acid, and mixtures thereof. In certain preferred embodiments, the volatile organic acid is present in the substantially water-insoluble composition at a concentration selected from less than 5% by weight of solids, less than 2% by weight of solids and less than 1% by weight of solids.

Preferably, the weight-average molecular weight is between 50,000 and about 2,000,000 and a degree of deacetylation of between about 60% and 100%. More preferably, the degree of deacetylation is at least 70%, more preferably at least 80%, yet more preferably at least 90%, and most preferably at least 95%. In another embodiment, the degree of deacetylation is at least 99%.

In a preferred embodiment, the non-volatile organic acid and the α- or β-chitosan are present in the substantially water-insoluble composition of the above-identified method at a mole ratio of non-volatile acid/chitosan of between about 0.2 to about 0.99, about 0.2 to about 0.85, about 0.2 to about 0.8, or about 0.2 to about 0.6. In a preferred embodiment, the mole ratio of non-volatile acid/chitosan is between about 0.4 and about 0.95, about 0.4 to about 0.85, or about 0.4 to about 0.8. In an alternate embodiment, the mole ratio of non-volatile acid/chitosan is between about 0.95 and about 0.99. Likewise, the volatile organic acid is present in the substantially water-insoluble composition at a concentration selected from less than 5% by weight of total solids, less than 2% by weight of total solids and less than 1% by weight of total solids.

Preferably, the composition comprising α- or β-chitosan has a weight-average molecular weight of between about 50,000 and about 2,000,000 and a degree of deacetylation of between about 60% and 100%.

In accordance with the present invention, unless otherwise defined herein, scientific and technical terms used in connection with the invention shall have the meanings that are commonly understood by those of ordinary skill in the art. Further, unless otherwise required by context, singular terms shall include the plural and plural terms shall include the singular. Generally, nomenclatures used in connection with, and techniques of, column chromatography, acid-base chemistry, polymer chemistry, including viscoelastic measurements, and molecular biology described herein are those well known and commonly used in the art.

The following terms, unless otherwise indicated, shall be understood to have the following definitions:

The term “predetermined” is being used to refer to the dial-in-absorption properties of the substantially water-insoluble composition comprising α- or β-chitosan. The dial-in-absorption property may be determined by using a single batch of chitosan, separating this batch into at least three different samples, placing at least three different ratios of volatile/non-volatile organic acids into each of the three samples, treating the samples with freeze-drying, heating and/or solvent extraction to form a dried pad, placing the dried pads in serum, blood, saline or water and measuring the ratio of non-volatile acid/chitosan versus fluid pick-up of grams per 1000 grams of pad solid. The ratio of non-volatile acid/chitosan at maxiumum fluid pick-up may then be used to prepare a batch of chitosan having a predetermined absorption. Thus, the predetermined amount of fluid absorption is directly related to the initial mole ratios of volatile organic acid to non-volatile organic acid to chitosan.

As used herein, the term “substantially water-insoluble” refers generally to a composition comprising α- or β-chitosan and a non-volatile organic acid that is capable of swelling to its equilibrium volume, while dissolving minimally or not at all in an aqueous environment. The term “dissolving minimally” refers to the α- or β-chitosan dissolving less than 10%, preferably less than 5% and most preferably, less than 2% in water. Additionally, this composition refers to a material that is capable of swelling fluids such as water, serum, blood, saline, and mixtures thereof. The term “substantially water-insoluble” may also refer to a composition comprising α- or β-chitosan and a non-volatile organic acid having a minimal amount of a component selected from water, volatile organic acid, growth factors, antibiotics, and mixtures thereof. The composition may also comprise residual amounts of solvents used to extract the volatile organic acid component. Typically, a residual or minimal amount of a component, e.g., volatile organic acid, refers to that component being present in the composition at a concentration of less than 5%, preferably less than 2%, more preferably less than 1% by weight of total solids.

The term “volatile organic acid” according to this invention comprises monoprotic acids, wherein the monoprotic acid generally has a melting point of less than 125° C. The non-volatile organic acids according to this invention comprise polyprotic acids, wherein the polyprotic acid generally has a melting point of greater than 125° C. For example, volatile organic acids according to this invention include, but are not limited to, the monoprotic acids found in Table 1.

Non-volatile organic acids according to this invention include, but are not limited to, the polyprotic acids found in Table 2.

The term “moles of organic acid” as used herein refers to the number of molar equivalents of acid, wherein a polyprotic acid, such as succinic acid, has two molar equivalents of acid per molecule of succinic acid. Likewise, a monoprotic acid, such as acetic acid, has one molar equivalent of acid per molecule of acetic acid.

TABLE 1
Physical constants for monoprotic
volatile acids.

| | | Melting | | |
|---|---|---|---|---|
| | Mol. | Point | | |
| Acid | Wt. | (° C.) | K | pKa |
| acetic | 60.05 | 16.6 | 1.75 × 10⁻⁵ | 4.75 |
| acid | | | | |
| acrylic | 72.06 | 13 | 5.6 × 10⁻⁵ | 4.25 |
| acid | | | | |
| iso- | 88.11 | −47 | 1.44 × 10⁻⁵ | 4.84 |
| butyric | | | | |
| acid | | | | |
| n-butyric | 88.11 | −7 to −5 | 1.54 × 10⁻⁵ | 4.81 |
| acid | | | | |
| formic | 46.03 | 8.4 | 1.86 × 10⁻⁴ | 3.75 |
| acid | | | | |
| propionic | 74.08 | −20.8 | 1.34 × 10⁻⁵ | 4.87 |
| acid | | | | |
| pyruvic | 88.06 | 13.8 | 1.4 × 10⁻⁴ | 2.39 |
| acid | | | | |

TABLE 2
Physical constants for polyprotic
non-volatile acids.

| | | Melting | | | |
|---|---|---|---|---|---|
| | Mol. | Point | | pKa₂ | pKa₃ |
| Acid^{a} | Wt. | (° C.) | pKa₁ | (K) | (K) |
| adipic acid | 146.14 | 152-154 | 4.43 | 5.41 | — |
| L-ascorbic acid | 176.12 | 193 | 4.17 | 11.80 | — |
| citric acid | 192.12 | 152-154 | 3.14 | 4.77 | 6.39 |
| fumaric acid | 116.07 | 299-300 | 3.05 | 4.94 | — |
| | | (S) | | | |
| L-glutamic acid | 147.13 | 205 | 2.19 | 4.31 | — |
| | | (dec) | | | |
| iminodiacetic | 133.10 | 243 | 2.98 | 9.89 | — |
| acid | | (dec) | | | |
| itaconic acid | 130.10 | 166-167 | 3.85 | 5.45 | — |
| lactic acid | 90.08 | 24 | 3.86 | | |
| maleic acid | 116.07 | 140-142 | 1.83 | 6.07 | — |
| L-malic acid | 134.09 | 101-103 | 3.40 | 5.05 | — |
| nitrilotriacetic | 191.14 | 246 | 3.03 | 3.07 | 10.00 |
| acid | | (dec) | | | |
| 2-pyrrolidone-5- | 129.12 | 183-185 | | | — |
| carboxylic acid | | | | | |
| succinic acid | 118.09 | 188-190 | 4.16 | 5.61 | — |
| L-tartaric acid | 150.09 | 170-172 | 2.98 | 4.34 | — |

^{a}Acid includes racemic mixtures and L or D racemates.

Chitosan is a soluble derivative of chitin and its degree of solubility in aqueous and organic environments depends on the degree of deacetylation. The term “degree of deacetylation” or “deacetylation degree” refers to the average number of acetyl groups chemically converted to amine groups on a single chitosan chain.

In addition to the degree of deacetylation, another variable in α- and β-chitosan compositions relates to molar mass distribution of the α- and β-chitosan. This distribution is typically characterized in terms of number-average molar mass (Mₙ) and weight-average molar mass (M_{w}) but can also be characterized as z-average molar mass (M_{z}) and viscosity-average molar mass (Mᵥ) (see, e.g., Young, R. J. and Lovell, P. A., Introduction to Polymers, 2^{nd} ed., Chapman & Hall, New York, (1991)).

The term “hemostat” refers to a device or a chemical substance which stops blood flow. A hemostat according to this invention can stop blood flow by clotting. The term “hemostasis” refers to the arrest of bleeding from an injured blood vessel. As known in the art, fibroplasia refers to the normal or abnormal formation of fibrous tissue during wound healing.

“Viscoelasticity” defines a polymer or a materials response to external forces in a manner that is intermediate between the behavior of an elastic solid and a viscous liquid (see, e.g., Aklonis, John J. and MacKnight, William J., Introduction to Polymer Viscoelasticity, 2^{nd} ed., John Wiley and Sons, New York, (1983)).

The term “tensile strength” refers to the maximum amount of tensile stress than can be applied to a material or polymer before it ceases to be elastic. For example, excess force can cause the material to break or fracture.

The compositions comprising α- or β-chitosan according to this invention may be used in the treatment of open wounds or bleeding sites in a mammal. The term “mammal” includes, but is not limited to, humans, non-human primates, rodents, canines, pigs, cats, cows, horses, and goats. In certain preferred embodiments, the mammal is human.

In order that this invention may be better understood, the following examples are set forth. These examples are for the purpose of illustration only and are not to be construed as limiting the scope of the invention in any manner.

### EXAMPLES

The following materials were used in the examples set forth below.

Materials

Commercially-available α-chitosans, derived from Opelio crab, Dungeness crab, pink shrimp, King crab, Tanner crab, crayfish and American lobster, and having a molecular weight range of between about 50,000 and about 2,000,000 and a degree of deacetylation between about 70% and about 100%, were obtained from various sources. For example, Opelio crab was obtained either in Alaska or eastern Canada prior to being frozen and shipped to Vietnam for meat extraction. Dungeness crab, pink shrimp, King crab, and Tanner crab were obtained from waters near Seattle, Wash. Note that high levels of deacetylation can be achieved by techniques known in the art, or e.g., reprocessing the samples with 50% NaOH at 70° C. in an air/oxygen starved environment (percent deacetylation can be determined by titration with a 0.01 M NaOH/H₂O solution). Similarly, β-chitosan was derived from Logio squid found in waters near Seattle, Wash. Note that when β-chitin is deacetylated by strong base, it reverts back to the alpha form. However, when β-chitin is deacetylated enzymatically, it stays in the beta form. According to this invention, β-chitin may be converted to β-chitosan by deacetylation with enzyme. Glacial acetic acid, tartaric acid, succinic acid, sodium chloride, and fetal bovine serum (FBS) were obtained from commercial vendors.

Analytical Techniques and Assays

Ion Exchange High Performance Liquid Chromatography. Ion exchange high performance liquid chromatograms (IE-HPLC) were obtained on a Waters (Milford, Mass.) instrument (Waters 510 solvent delivery system connected to a Waters 680 automated gradient controller) equipped with a Shodex KC-g guard column placed in line with a Shodex KC-811 ion exchange column (8 mm ID×300 mm length). Samples were dissolved in the mobile phase solution (0.1% H₃PO₄), an internal standard was added, and the pH was raised to 6.5 to precipitate any dissolved chitosan. Samples were then filtered (filter pore size, 0.2 μm) prior to injection into a Waters Model U6K universal injector. Elution profiles were monitored at 332.8 nm (Wyatt Dawn DSP laser photometer) or between 950+nm to 30 nm (Knauer K-2300 Refractive index detector sensitivity 8*10⁻⁸ delta N) using an isocratic method (1.0 mL/min at 50° C. over approximately 13 minutes). All chemicals were HPLC grade. Data was collected and analyzed using Wyatt Astra program and Table Curve2D 5.0 automated curve fitting software (Santa Barbara, Calif.). System accuracy was checked using injections containing known amounts of acid. Calibration curves were determined for individual acids using a series of dilutions and calculating the area of the respective peaks collected with the Knauer RID.

Molecular Weight of Chitosan and Size Exclusion Chromatography (SEC). Molecular weight measurements, i.e., Mₙ, M_{w}, M_{z}, were made using size exclusion chromatography (SEC) employing a TosoHass TSK guard column placed in line with a TosoHass GMPW TSK-Gel column (7.5 mm ID×30.0 cm length). Radius moments, i.e., Rₙ, R_{w}, R_{z}, were also collected along with molecular weight distribution data. The mobile phase comprised 0.25 M acetic acid and 0.25 M sodium acetate in H₂O. Chromatograms were collected at a flow rate of 0.5 mL/min at ambient temperature, wherein the run time was generally 15 minutes. Data was collected with the Knauer RID and the Dawn DSP and molecular weight determinations were made using Wyatt technology Astra software (version 4.73.04). System accuracy was determined using injections of known Dextran standards (Average Molecular weights 41,272 and 2,000,000) from Sigma Chemical (St. Louis, Mo.).

Determination of Chitosan Pad Weights Before and After Absorption. Weights were determined using a Denver XE-100 analytical balance. Dry pads were weighed to 1/10,000^{th} accuracy and then placed in a dish with the corresponding liquid (e.g., saline, H₂O, etc.). The wet pads were removed from the liquid, allowed to drip dry a few seconds, and then weighed in a Petri dish. The pads were then removed from the dish and the weight of the dish and the extra liquid remaining in the dish were subtracted from the original weight.

### Example 1

Preparation of α-chitosan acetate pads. Chitosan acetate pads derived from various sources were prepared by dissolving 1 g of dry chitosan in 1 g of glacial acetic acid (volatile acid) and 98 g of distilled water, the mixture was then poured into 4×4 inch plastic moulds to a depth of 0.25 inches. The samples were then frozen at −20° C. and freeze-dried at 30×10⁻³ millibars for 18 hours. The resulting chitosan pads contained from between about 20% to about 1% acetic acid and from between about 20% to about 1% water, wherein the remainder of the material was chitosan. The pads were then annealed at 60° C. for a selected amount of time, e.g., 0, 1, 2, 3, 4, and 25 hours.

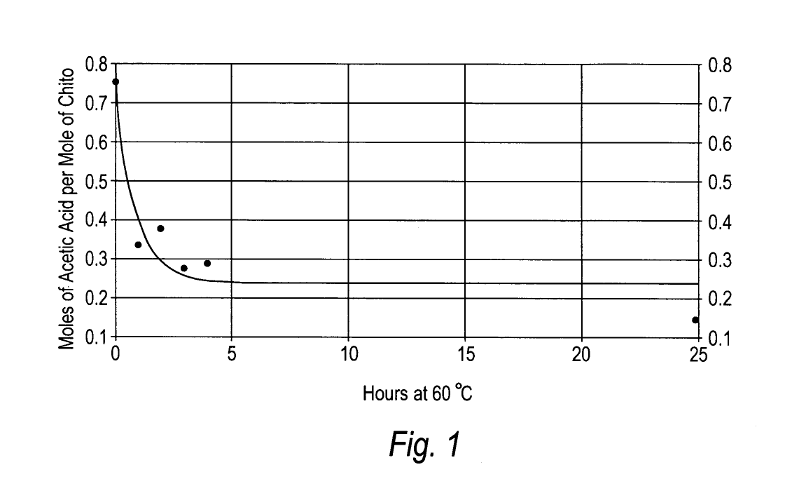

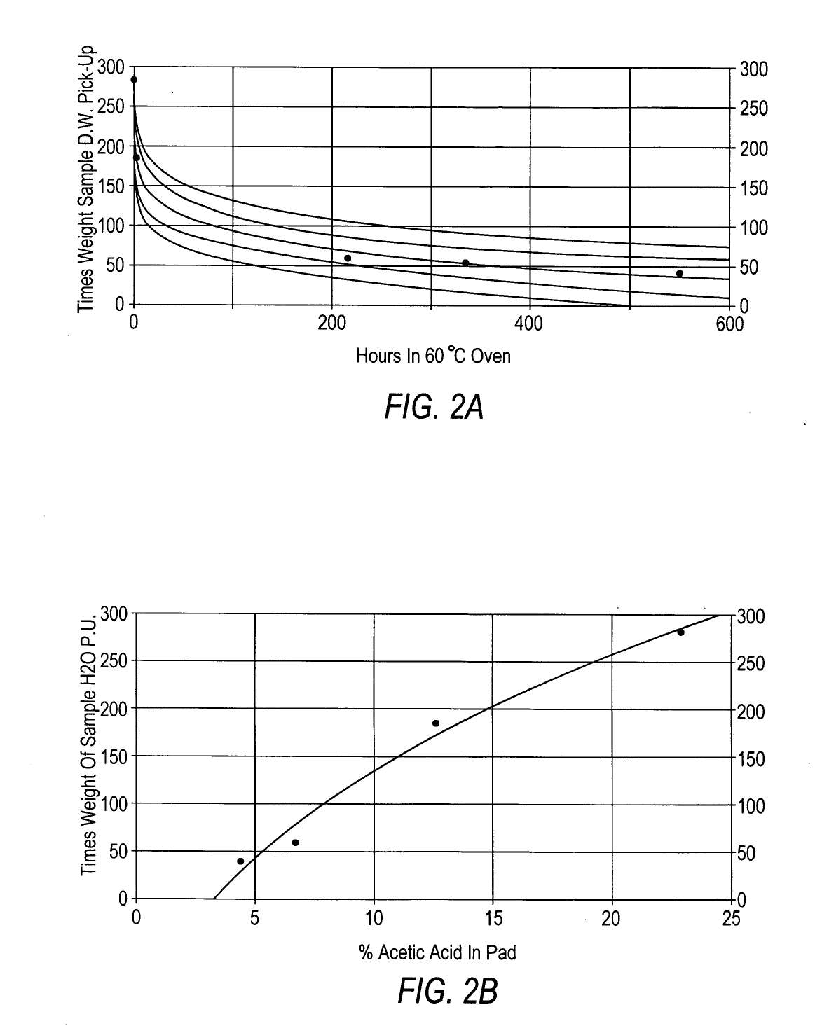

FIG. 1 shows the loss of moles of acetic acid per mole of chitosan by heating the chitosan acetate pads at 60° C. for varying times. FIG. 2A illustrates the relationship between heating the chitosan-acetate sample at 60° C. for various times and water absorption, while FIG. 2B shows the relationship between the percent acetic acid in chitosan pad and the amount of water absorption of chitosan pad (expressed as times weight of chitosan pad). By heating the chitosan acetate pads, the amount of acetic acid is reduced, which in turn decreases the amount of water absorption. In addition, the chitosan acetate pads loose part of their acidity upon storage due to the residual volatilization of acetic acid. As stated above, the loss of acid in the chitosan pad reduces the amount of absorption. For this reason, using a volatile acid alone in the preparation of chitosan does not provide stability upon storage.

### Example 2

Absorption of fetal bovine serum and sodium chloride from chitosan-acetate pads. Chitosan acetate pads were generally prepared according to Example 1. Ten samples of freeze-dried chitosan acetate pads as described in Table 3 were tested and fetal bovine serum absorption was reported.

TABLE 3
Characteristics and serum absorption for
chitosan acetate pads.

| | | | Fetal Bovine | | |
|---|---|---|---|---|---|
| | | | Serum | | |
| | | moles | Absorption | | |
| | Sample | acetic | (x increase | | |
| Sam- | Description | acid/ | in mass of | | Molecular |
| ple | (Opelio | moles | of chitosan | % | Weight/ |
| No. | crab) | chitosan | acetate pad) | Deacetylation | 1000 |
| 1 | vc 9/12-1 | 0.58 | 50.17 | 94.00 | 159.20 |
| 2 | vc 9/12-3 | 0.48 | 48.54 | 94.00 | 159.20 |
| 3 | 10 9/20-0 | 0.70 | 45.30 | 88.00 | 105.60 |
| 4 | 10 9/20-2 | 0.56 | 41.00 | 88.00 | 105.60 |
| 5 | 10 9/20-1 | 0.56 | 40.20 | 88.00 | 105.60 |
| 6 | 10 9/20-3 | 0.55 | 39.70 | 88.00 | 105.60 |
| 7 | 9 9/20-0 | 0.85 | 40.00 | 86.90 | 106.30 |
| 8 | 9 9/20-1 | 0.62 | 38.90 | 86.90 | 106.30 |
| 9 | 9 9/20-3 | 0.63 | 38.20 | 86.90 | 106.30 |
| 10 | 9 9/20-2 | 0.68 | 35.20 | 86.90 | 106.30 |

The variables and quantities in Table 3 were then used to derive an equation to predict the ability of the chitosan pad to absorb fetal bovine serum. The times or fold change in mass of the chitosan acetate pad due to serum absorption was calculated as follows:
Times weight of original chitosan pad=K+[(a)(% deacetylation)]+[(b)(moles acid/moles chitosan)] [1],

wherein K is an experimentally-determined constant and a and b are experimentally-determined coefficients. A linear regression fit to the fetal bovine serum absorption results of Table 3 yielded equation 1 wherein K=−179.34, a=17.84 and b=2.36 (correlation coefficient, r²=0.92). Note that molecular weight does not appear in this calculation as it is co-linear with some of the other variables. Equation 1 suggests that the percent deacetylation of the chitosan (or potential cationic amine groups) has a greater effect on the serum pick-up than that of the ratio of moles of acid/moles of chitosan. In the case of 0.15 M sodium chloride, nine samples of freeze-dried chitosan acetate pads, as described in Table 4, were tested and saline absorption was reported.

TABLE 4
Saline absorption for chitosan acetate pads.

| | | | 0.15 M | | | | |
|---|---|---|---|---|---|---|---|
| | | | NaCl | | | | |
| | | moles | Absorption | | | | |
| | | acetic | (x | | | | |
| | | acid per | increase | | | | |
| Sample | Sample | moles | in mass | % | M.Wt./ | Moles | Moles |
| No. | Description | chitosan | of pad) | Deacetylation | 1000 | acid | chitosan |
| 1 | 9a | 0.57 | 45.89 | 86.90 | 106.00 | 2.87 | 5.04 |
| 2 | 9b | 0.63 | 47.55 | 86.90 | 106.00 | 3.12 | 4.95 |
| 3 | 8a | 0.64 | 56.97 | 92.00 | 102.30 | 3.17 | 4.93 |
| 4 | 8b | 0.68 | 81.62 | 92.00 | 102.30 | 3.31 | 4.88 |
| 5 | 8c | 0.68 | 65.44 | 92.00 | 102.30 | 3.31 | 4.88 |
| 6 | Viet2&3-1 | 0.50 | 42.44 | 94.00 | 137.00 | 2.57 | 5.17 |
| 7 | −2.00 | 0.73 | 61.56 | 94.00 | 137.00 | 3.56 | 4.80 |
| 8 | −3.00 | 0.65 | 63.04 | 94.00 | 137.00 | 3.22 | 4.93 |
| 9 | −4.00 | 0.73 | 71.47 | 94.00 | 137.00 | 3.53 | 4.82 |

The variables and quantities in Table 4 were then used to derive an equation to predict the ability of the chitosan pad to absorb saline. The times or fold change in mass of the chitosan acetate pad due to absorption was calculated according to equation 2 was calculated as follows:
Times weight of original chitosan pad=K+[(a)(% deacetylation)]+[(b)(moles acid/moles chitosan)]−[(c)(molecular weight of chitosan)] [2],
wherein K is an experimentally-determined constant and a, b, and c are experimentally-determined coefficients. A linear regression fit to the saline absorption results of Table 4 yielded equation 2 wherein K=−198.40, a=109.75, b=2.49, and c=0.346 (correlation coefficient, r²=0.87).

Equations 1 and 2 and the results reported in Tables 3 and 4 indicate that a significant correlation exists between the absorption of serum and saline in different chitosan samples. To test this correlation, absorption data from five serum and five saline samples in Tables 3 and 4 was correlated according to Equation 3 as follows:
Serum absorption=−27.150+(0.565*saline absorption)+(0.146*molecular weight) [3],
wherein the correlation coefficient was 0.98.

The results of the initial serum and saline absorption studies demonstrate that the maximum amount of serum and saline absorption are modulated by the percent deacetylation, moles of acid/moles of chitosan, and molecular weight of chitosan. To a large extent, the percent deacetylation and molecular weight are controlled during the processing and manufacture of raw shell, squid, or other source of chitin to chitin and then to chitosan. Relevant factors in this processing include freshness and specie, strength and kind of acid used during the conversion of specie to chitin, temperature in drying the chitin, strength and ratio of alkali/chitin used to deacetylate, temperature and time of deacetylation, use of a non-oxygenating atmosphere during deacetylation, and proper drying temperatures.

### Example 3

Effect of additional acetic acid on absorption of chitosan-acetate pads. Chitosan acetate pads were prepared by dissolving Opelio crab chitosan (2 g) in 196 mL of 2% acetic acid, freeze-drying the sample for 16.5 hours at 33×10⁻³ mbars at −48° C., heating the sample in a 65° C. oven for 24.25 hours, and soaking the samples in a 0.15 M sodium chloride for 10 minutes. The chitosan-acetate pad was then removed and weighed resulting in a 35.91 g increase in pad weight. One mL of distilled water containing 0.002 g of acetic acid was added to this treated sample. After equilibrating the sample for 5 minutes, the sample was then added to a weighing dish containing 0.15 M saline. The sample expanded and become colorless and upon re-weighing, the sample pad was 87.25 times the weight of the original sample without the addition of saline. The above process was repeated on two additional chitosan-acetate samples. The first sample pad yielded an original saline absorption of 42.77 times the original weight and after acetic acid addition, 100.46 times the original pad weight. The second sample pad yielded an original saline absorption of 41.91 times the original weight and after acetic acid addition, 71.44 times the original pad weight.

### Example 4

Effect of annealing on fluid absorption using chitosan-acetate pads. Chitosan-acetate pads using β-chitin derived from squid 1 (0.47% ash, Loligo opalescens) and squid 2 (0.215 ash, Loligo opalescens) were prepared generally according to Example 1. After freeze-drying, the chitosan acetate pads were annealed at 60° C. for 1, 2, 3 and 23 hours. The results are reported in Table 5.

TABLE 5
Summary of values of chitosan acetate pads after
heating at 60° C. over 0-23 hours.

| | Saline | | | | |
|---|---|---|---|---|---|
| | absorption | | | | |
| | (times | | | | |
| Hours | weight of | | | | Acetic |
| at | original | % acetic | % | | acid/acetic |
| 60° C. | pad) | acid | chitosan | % water | acid + water |
| 1 | 33.60 | 14.90 | 71.40 | 13.70 | 0.52 |
| 2 | 28.90 | 12.40 | 69.60 | 18.00 | 0.41 |
| 3 | 23.36 | 10.50 | 69.60 | 19.90 | 0.35 |
| 24 | 22.70 | 7.40 | 69.70 | 22.90 | 0.24 |

The data demonstrates that the acetic acid is removed over time while chitosan remains constant. Also, saline absorption decreases with a decrease in acetic acid ionizable groups in the polymer.

### Example 5

Summary of fluid absorption for various chitosan acetate pads. The results of fluid absorption for various chitosan acetate pads are show in Table 6.

TABLE 6
Absorption for chitosan-acetate pads.

| | Blood | Saline | Serum |
|---|---|---|---|
| | absorption | absorption | absorption |
| | (times weight | (times weight | (times weight |
| Chitosan | of original | of original | of original |
| source | pad) | pad) | pad) |
| Squid 1 | 30.39 | 5.81 | 4.90 |
| Squid 2 | 22.23 | 42.38 | 6.26 |
| Dung 1 | 8.78 | 6.29 | 19.17 |
| Dung 2 | 7.17 | 42.08 | 28.77 |
| *Derma | 0.56 | 0.48 | 0.39 |
| *Carragauze | 0.55 | 0.47 | 0.56 |
| *Aldress | 10.7 | 10.17 | 10.73 |
| *Comfeel U | 0.3 | 0.16 | 0.19 |
| *Coloplast | 0.42 | 0.41 | 0.44 |
| *Duoderm | 0.44 | 0.17 | 0.27 |
| *Combiderm | 6.78 | 6.85 | 6.81 |
| *Kalostat | 21.23 | 20.94 | 19.76 |

*Competitive pad not made with chitosan.

### Example 6

Preparation of chitosan tartrate-acetate discs. Chitosan tartrate-acetate discs were prepared as follows. Four solutions of Opelio crab chitosan (96% DEA) were prepared: 4-A (1.0025 g chitosan, 0.9917 g tartaric acid, 98.12 g distilled water), 4-B (1.0003 g chitosan, 0.6927 g tartaric acid, 0.0929 g acetic acid, and 98.20 g distilled water), 4-C (1.0001 g chitosan, 0.7847 g tartaric acid, 0.0551 g acetic acid, 98.20 g distilled water) and 4-D (1.0006 g chitosan, 0.6926 g tartaric acid, 0.1117 g acetic acid, 98.20 g distilled water). Three pads were poured from each solution. Pads 1 and 2 of the four solutions were frozen at −20° C. and lyophilized for 24 hours under vacuum (less than 133×10⁻³ mbars and reaching over 30×10⁻³ mbars over 24 hours). Wet weights and dry weights were recorded as follows: Pad 4-A1 (20.9062 g wet, 0.4471 g dry), Pad 4-A2 (24.6821 g wet, 0.5254 g dry), Pad 4-B1 (20.4570 g wet, 0.4436 g dry), Pad 4-B2 (16.7616 g wet, 0.3676 g dry), Pad 4-C1 (23.0051 g wet, 0.5060 g dry), Pad 4-C2 (16.5061 g wet, 0.3679 g dry), and Pad 4-D1 (20.1025 g wet, 0.4013 g dry), Pad 4-D2 (22.4500 g wet, 0.4504 g dry). Upon extraction and HPLC analysis, it was found that the majority of tartaric acid remained with the chitosan after freeze-drying, whereas only a residual amount of volatile acid remained. For example, a minor loss of 0.24% of the tartaric acid mass in grams was lost for Pad D1, whereas 88% of the acetic acid mass was lost for the same pad.

### Example 7

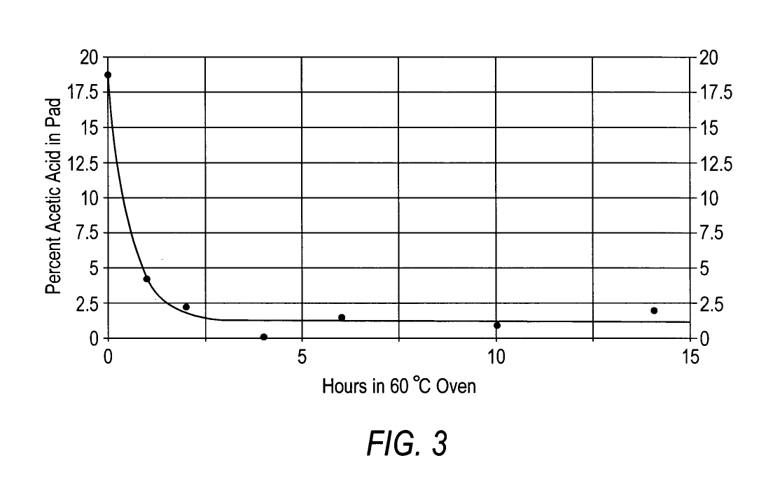

Effect of heat on chitosan tartrate-acetate discs. Lyophilized chitosan tartrate-acetate discs were prepared according to Example 6. In order to determine the effect of heat on the residual volatile acid component remaining with the chitosan pad, one inch discs of the chitosan tartrate-acetate samples were cut and placed in a 60° C. oven for 0, 1, 2, 4, 6, 10, and 14 hours. The moles of acetic acid remaining after each time increment were determined by placing each disc in mobile phase, adjusting the pH of the liquid to greater than seven (to precipitate any dissolved chitosan) and filtering the filtrate through a 0.2 μm filter. The filtrate was then injected into an HPLC using an internal standard (tartaric acid, 7.969×10⁻⁴ g/mL). The results are presented in Table 7 and FIG. 3 and show that the percent acetic acid in the chitosan pad decreased from 18.2% to 0.1% by heating at 60° C. over a time period of between 0 to 14 hours. In addition, the chitosan remained constant at 71.5% and the tartaric acid component also remained constant at 13.45±0.63 percent by heating at 60° C. over the same time period (not shown).

TABLE 7
Percent acetic acid remaining in chitosan tartaric-
acetate pad after heating at 60° C. for
various times.

| Time (hours) of | |
|---|---|
| heating chitosan | Percent acetic acid |
| tartaric-acetate pad | remaining in pad |
| at 60° C. | after heating |
| 0 | 18.9 |
| 1 | 4.2 |
| 2 | 2.2 |
| 4 | 0.1 |
| 6 | 1.5 |
| 10 | 0.9 |
| 14 | 2.0 |

### Example 8

Preparation of chitosan succinate-acetate pads. Chitosan succinate-acetate discs were prepared by mixing 0.5 g SQT chitosan, 0.0902 g succinic acid (non-volatile acid), 0.0606 g acetic acid (volatile acid) and 49.3530 g distilled water until complete dissolution of chitosan was achieved. A 21.0975 g aliquot of this mixture was then poured into a weighed Petri dish, frozen at −20° C. and lyophilized for 24 hours under vacuum at 30×10⁻³ millibars. The Petri dish was then re-weighed to determine the resulting weight of the chitosan succinate-acetate pad. A net weight of 0.2670 g resulted. Upon extraction, it was found that the succinic acid remained with the chitosan after freeze-drying whereas only a residual amount of volatile acid remained.

### Example 9

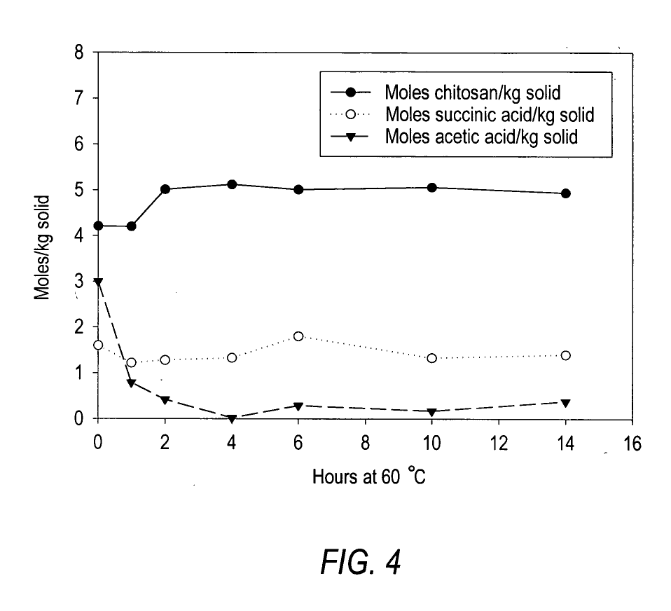

Effect of heat on chitosan succinate-acetate pad. Lyophilized chitosan succinate-acetate pads were prepared according to Example 8. In order to determine the effect of heat on the non-volatile organic acid component and the residual volatile acid component remaining with the chitosan, one inch pads of the chitosan succinate-acetate samples were cut and placed in a 60° C. oven for 0, 1, 2, 4, 6, 10, and 14 hours. The moles of succinic acid and acetic acid remaining after each time increment were determined by placing each pad in distilled water, adjusting the pH of the liquid to greater than seven (to precipitate any dissolved chitosan) and filtering the filtrate through a 0.2 μm filter. The filtrate was then injected into an HPLC using an internal standard. The results are presented in Table 8 and FIG. 4 and show that the moles of succinic acid/kg solids and the moles of chitosan/kg solids do not change significantly with heating at 60° C. between 0 and 14 hours; the non-volatile acid remained constant at 1.353±0.254 moles and the chitosan remained constant at 4.75±0.429 moles. The volatile acid, however, decreases over time as shown in FIG. 4 and an exponential fit of the data yielded the following coefficents: a=0.227, b=2.841 and c=0.633 (correlation coefficient, r²=0.99). Although aging tests were not performed on the pads at room temperature, the above data describes the stability of chitosan and non-volatile succinic acid within the pad. This data demonstrates that one is able to modulate the remaining non-volatile acid in the chitosan pad so that the conditions for maximum absorption and stability are achieved.

TABLE 8
Summary of values of chitosan succinic-acetate pads
after heating at 60° C. over 0-14 hours.

| | Moles | Moles | |
|---|---|---|---|
| Moles | succinic | acetic | Hours |
| chitosan/kg | acid/kg | acid/kg | at |
| solids | solids | solids | 60° C. |
| 4.21 | 1.06 | 3.07 | 0 |
| 4.92 | 1.22 | 0.79 | 1 |
| 5.01 | 1.28 | 0.42 | 2 |
| 5.12 | 1.33 | 0.02 | 4 |
| 5.01 | 1.85 | 0.29 | 6 |
| 5.06 | 1.33 | 0.17 | 10 |
| 4.94 | 1.40 | 0.38 | 14 |

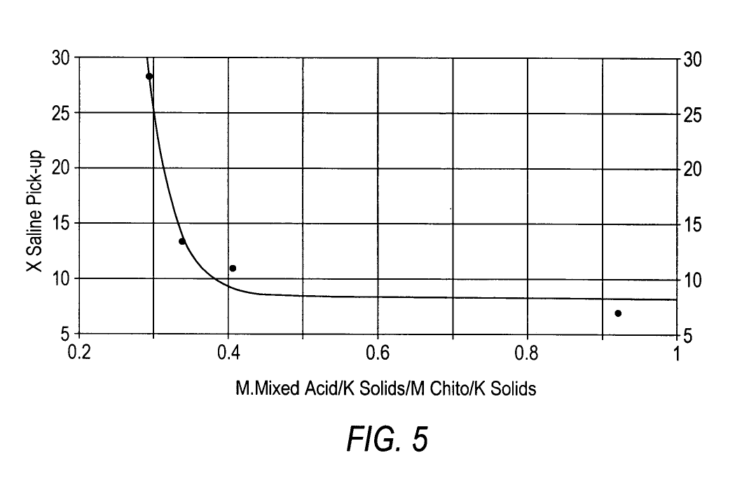

Additionally, Table 9 and FIG. 5 illustrate the effect of the moles of mixed acid (volatile and non-volatile organic acids) per kilogram solids and the moles of chitosan per kilogram solids on the absorption of 0.15 M saline after annealing the chitosan pads at 60° C. for 0, 1, 2, and 10 hours. FIG. 5 demonstrates that as the ratio of moles mixed acid per kilogram solids to moles of chitosan per kilogram solids decreases, the saline absorption increases. As demonstrated above, the amount of non-volatile acid and chitosan do not change with heating, thus, it is the amount of non-volatile acid present, and reduction in volatile acid that give rise to increased absorption. By controlling the amount of volatile and non-volatile acid in the chitosan pad throughout the processing, the absorption of various fluids can be controlled, as well as the shelf-life/stability of the pad.

TABLE 9
Effect of volatile and non-volatile acid on saline
absorption in chitosan-acetate pads.

| | | Saline absorption |
|---|---|---|
| | (Moles of mixed | (Times weight of |
| Hours | acid/kg solids)/(moles | original chitosan |
| at 60° C. | chitosan/kg solids) | pad) |
| 10 | 0.296 | 28.4 |
| 2 | 0.339 | 13.4 |
| 1 | 0.408 | 11.0 |
| 0 | 0.920 | 7.07 |

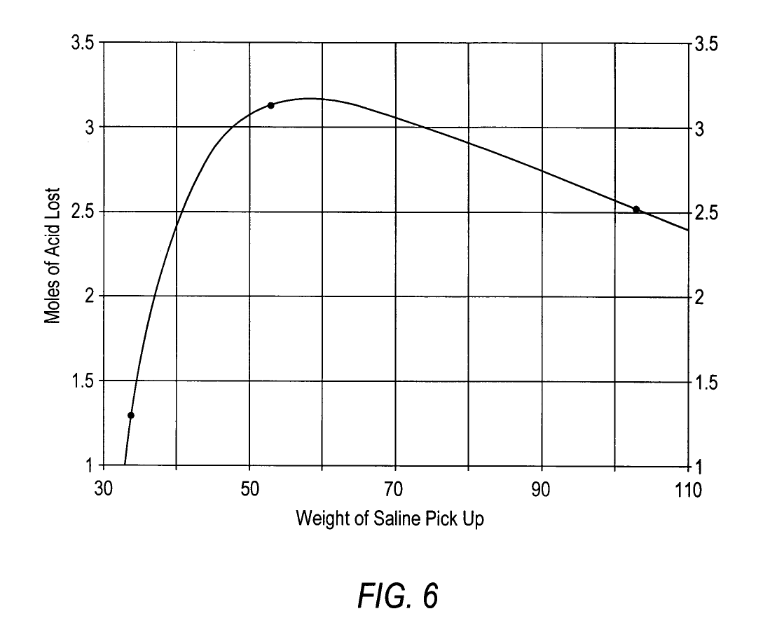

Table 10 and FIG. 6 illustrate the relationship between saline absorption of the chitosan succinate pad versus moles of volatile acid lost.

TABLE 10
Weight of saline absorbed versus moles of
volatile acid lost in chitosan succinate pads.

| | Saline absorption |
|---|---|
| Moles of volatile | (times weight of |
| acid lost | original pad) |
| 1.29 | 33.8 |
| 3.13 | 53.2 |
| 2.91 | 80.1 |
| 2.51 | 102.9 |

### Example 10

Chitosan Salt Absorption and Stability Studies. Table 11 summarizes results obtained for chitosan tartrate-acetate (S1T2) and chitosan succinate-acetate (CFB-1, CFA-2, CFB-2) samples. Squid or cuttlefish chitosan was dissolved in a succinic-acetic acid solution. Plates were poured, frozen and freeze-dried. Upon removal from the freeze-drier, the samples were tested for pick-up and analyzed for acid content with ion exchange chromatography. The testing and analysis was repeated on day 268 or 203. These results demonstrate that the samples remain stable over 200 days upon storage under ambient conditions. The results also demonstrate that the chitosan tartrate-acetate and chitosan succinate-acetate samples show significant absorption of 0.15 M saline and fetal calf serum after more than 200 days of storage at ambient temperatures.

TABLE 11
Chitosan salt stability.

| | | Times | 95% | | |
|---|---|---|---|---|---|
| | | Weight | Confidence | No. of | |
| Sample | Fluid | Pick-up | Range | Days | Temperature |
| S1T2 | 0.15 M | 44 | — | 268 | ambient |
| | NaCl | | | | |
| S1T2 | 0.15 M | 39.8 | 38.26-30.1 | 268 | ambient |
| | NaCl | | | | |
| CFB-1 | 0.15 M | 84.4 | — | 203 | ambient |
| | NaCl | | | | |
| CFB-1 | 0.15 M | 85.22 | 92.54-72.58 | 203 | ambient |
| | NaCl | | | | |
| CFA-2 | fetal | 37.3 | — | 203 | ambient |
| | calf | | | | |
| | serum | | | | |
| CFA-2 | fetal | 46.91 | 58.53-35.30 | 203 | ambient |
| | calf | | | | |
| | serum | | | | |
| CFB-1 | fetal | 67.5 | 69.63-43.27 | 203 | ambient |
| | calf | | | | |
| | serum | | | | |
| CFB-1 | fetal | 56.45 | — | 203 | ambient |
| | calf | | | | |
| | serum | | | | |

### Example 11

Saline Absorption Studies. Chitosan samples were prepared with chitosan species and nonvolatile organic acids according to Table 12. Osmotic pressure was derived using the ideal gas equation,
P=RT(n/V) [4],
where R is the gas constant (0.00831 Pa/(mol·K), T is the absolute temperature (296 K), n is the number of anions lost per kilogram of oven-dried chitosan salt, and V is the swelled volume of freeze-dried chitosan. Additionally, n is equal to the moles of chitosan per kg solids minus the moles of anions remaining (both non-volatile and volatile acid) per kilogram of solids. While not wishing to be bound by a particular theory, a smaller amount of anions lost, i.e., a larger n, results in an increase in osmotic pressure and consequently, an increased absorption. By varying the ratio of the non-volatile to volatile organic acid components in preparing a composition comprising α- and β-chitosan, an absorption curve similar to that in FIG. 6 may be generated to show the maximum absorption of a particular fluid for a specific article of manufacture.

According to results in Table 12, the chitosan pads having the largest osmotic pressures and consequently, absorption values, were those made from squid and king crab chitosan. Here, the ionization constant may also be used to characterize the non-volatile acid component of the composition, e.g., there is a difference in fluid absorption between succinic and tartaric acids used with the same specie of chitosan.

TABLE 12
Saline Absorption Studies.

| | | | | Osmotic | | Absorption |
|---|---|---|---|---|---|---|
| Sample | | Nonvolatile | Observations/ | Pressure | Ionization | (times |
| No. | Specie | Acid | Capillarity | (MPa) | Constant | pick-up) |
| K1S1 | King | succinic | Quick gel | 247 | 6.2 × 10⁻⁵ | 111 |
| | | | time; easy to | | | |
| | | | remove | | | |
| S1S2 | Squid | succinic | Quick gel | 174 | 6.2 × 10⁻⁵ | 132.5 |
| | | | time; | | | |
| | | | slightly | | | |
| | | | viscous | | | |
| D3T2A | Dungeness | tartaric | Dissolving | 21.5 | 9.1 × 10⁻⁴ | 17.2 |
| O1T2A | Opelio | tartaric | Instant gel; | 72.4 | 9.1 × 10⁻⁴ | 53.8 |
| | | | extraction by | | | |
| | | | utensil | | | |
| K1T1A | King | tartaric | Instant gel; | 122.5 | 9.1 × 10⁻⁴ | 50.6 |
| | | | extraction by | | | |
| | | | tweezers | | | |
| S1T1A | Squid | tartaric | Instant gel | 62.3 | 9.1 × 10⁻⁴ | 44 |

### Example 12

Determination of the stoichiometry between chitosan and organic acid (volatile and non-volatile acid)—calculations for deacetylation percentage of Sample SR1 Shrimp. To a dry sample of 0.1056 g chitosan (corrected weight adjusted for ash content, either commercially available or commercially available chitosan that had been further deacylated) 25 mL of 0.06 M HCl was added. The resulting solution was then titrated with 0.00988 M NaOH.

The following calculations were performed to determine the stoichiometry between chitosan and organic acid:
161.16 g/mol(formula weight chitosan)×63.9 mL(titrant)×0.00000986 M(molarity of titrant)×100/0.1056 g(weight of sample)=96.16% deacetylation [5].

### Example 13

Determination of formula weight of deacetylated chitin. In chitosan, a glucosamine monomer has a molecular weight of 161 g/mole, however, since chitosan materials are typically not 100% deacetylated, the formula weight of less than 100% deacetylated chitin must be calculated from the titration curve prior to the determination of the formula weight. The formula weight may be calculated as follows:

$$\begin{matrix}Molecular Weight Chitin = 203 g \text{/} mole , & [ 6 ] \\ Molecular Weight Chitosan ( 100 \% deacetylated ) = \\ 161 g \text{/} mole , & [ 7 ] \\ Mass of Material = 10 grams , & [ 8 ] \\ Formula Weight of Material = ( 0.90 \times 161 ) + \\ ( 0.10 \times 203 ) = 165.2 g \text{/} mol , & [ 9 ] \\ Weight Fraction Chitosan = ( 0.90 \times 161 ) / [ ( 0.90 \times 161 ) + \\ ( 0.10 \times 203 ) ] = 87.7 \% , & [ 10 ] \\ Weight Fraction Chitin = ( 0.10 \times 203 ) / [ ( 0.10 \times 203 ) + \\ ( 0.90 \times 161 ) ] = 12.3 \% , & [ 11 ] \\ Moles of Chitosan = ( 87.7 \times 10 ) / 161 = 0.0545 , & [ 12 ] \\ Moles of Chitin = ( 12.3 \times 10 ) / 203 = 0.0061 and , & [ 13 ] \\ Wt {fract}_{chitosan} = \frac{( {moles}_{chitosan} \times 161 g \text{/} mole )}{( mass of chitosan )} . & [ 14 ]\end{matrix}$$

### Example 14

Preparation of chitosan lactate-acetate pads and measurement of water, saline, and fetal bovine serum absorption. A 2.0010 g sample of chitosan was added to 1.0530 g of lactic acid, 0.0759 g of glacial acetic acid, and 96.80 g of distilled water and stirred until the chitosan was dissolved. After dissolution, the solution was filtered through a 1 μm syringe filter and poured into a 4″×4″ plate (2 per solution). The sample (30.05 g wet) was then cooled to −20° C. and subsequently freeze dried at 35×10⁻³ min/μg, at −51° C. for 24 hours and 16 minutes. The recovered weight of the sample was 0.88160 g. The resulting chitosan sample was then cut into 1″ diameter discs (4 discs/sample).

1^{st} Sample Disc

A dry pad (0.0600 g) was floated in 0.15 M saline for 1.3 min. It spread along the crystal line. After 10 min. the sample had spread but was not fully dissolved. At 11 min, the sample remained gooey and weighed 5.54 g (5.54−(0.0600/0.0600)=91.33 times pickup)

2^{nd} Sample Disc

A dry pad (0.0494 g) was floated in 0.15 M saline to give a final weight of 1.5927 g for the resulting wet pad, which corresponded to 32.24 times pickup with no dissolution of the pad.

3^{rd} Sample Disc

A dry pad (0.0729 g) was floated in dry fetal calf bovine serum. After 5 minutes, some edge absorption was noted. After 11 min., there was some very slow pick-up. After 21 min., the edge submerged, after 28 min., the edge of the pad had dissolved, and after 30 min. the sample was recovered and had a weight of 0.5030 g (0.5030−(0.0729/0.0729)=5.90 times pick-up).

4^{th} Sample Disc

A dry pad (0.530 g) was placed in 25 mL of distilled water and stirred until dissolved. The resulting solution was acid extracted with a 1 μm syringe filter and refiltered with a 0.45 μm filter. The resulting solution (0.0022 g/mL) was injected into a Wyatt DAWN Laser spectrophotometer. The molecular weight was M_{w}=1.796×10⁵ daltons (R_{w}=41.9 (0.7%)).

Opelio crab chitosan was prepared using various amounts of lactic acid, acetic acid, and water. The chitosan samples were then freeze-dried, titrated for composition, and subjected to distilled water pick-up, 0.15 M saline pick-up, and fetal bovine serum pick-up. It was found that some of the pads dissolved completely while the consistency of the others did not allow accurate weights to be obtained. These samples were not heat treated.

### Example 15

Preparation of chitosan glutamate-acetate pads. The following pads were prepared by first preparing a solution as described above and then freeze-drying the samples.
O1-100:
   1.009 g 01 chitosan
   0.8751 g glutamic acid
   98.2040 g distilled water
O1-90:
   1.0002 g 01 chitosan
   0.7868 g glutamic acid
   0.0370 g acetic acid
   98.2060 g distilled water
O1-80:
   1.0007 g 01 chitosan
   0.7005 g glutamic acid
   0.0705 g acetic acid
   102.7083 g distilled water
O1-70:
   1.0001 g 01 chitosan
   0.6148 g glutamic acid
   0.1068 g acetic acid
   98.2983 g distilled water

### Example 16

Determination of maximum absorption using elastic modulus. As described in the above examples, the modulation of the ratio of non-volatile to volatile acid in preparing a composition of α- or β-chitosan provides a way in which the absorption of the resulting articles can be adjusted.

The absorption behavior of α- or β-chitosan can be described as follows (adapted from Scanlan et al., Journal of Pulp and Paper Science, 18, 5, J188-190 (1992)). First, the removal of volatile acid will result in the formation of cationic amine groups along the backbone of the chitosan chain. These cationic groups can be neutralized by anions that diffuse into the chitosan matrix or chitosan wall wherein this diffusion causes an increase in osmotic pressure or swelling within the chitosan matrix and this swelling is used as the basis to obtain a bulk elastic modulus of the swollen cell wall.

Once this happens, a measurable bulk elastic modulus forms at the interface of the swollen chitosan wall/matrix and the surrounding environment.

In order to derive an elastic modulus from swelling measurements, the swelling of chitosan with changes in osmotic pressure must be considered. Hooke's law states that the effective elastic modulus is given by the stress (osmotic pressure) to strain (fractional increase in the swollen volume of the cell wall).

Osmotic pressure may be determined using the following equation:
Osmotic pressure=RT(n/V), [15],
where R is the gas constant (0.00831 Pa/(mole·K); T is the absolute temperature (296 K); n is the number of moles of volatile anion that is lost through vaporization by heat, vacuum, or by solvent action; and V is the swollen volume.

Strain may be determined using the following equation:
(V−Vₒ)/(V_{c}+Vₒ) [16],
where Vₒ is the specific water content of the chitosan under the conditions of testing and V_{c} is the specific volume of chitosan (0.7 mL/g).

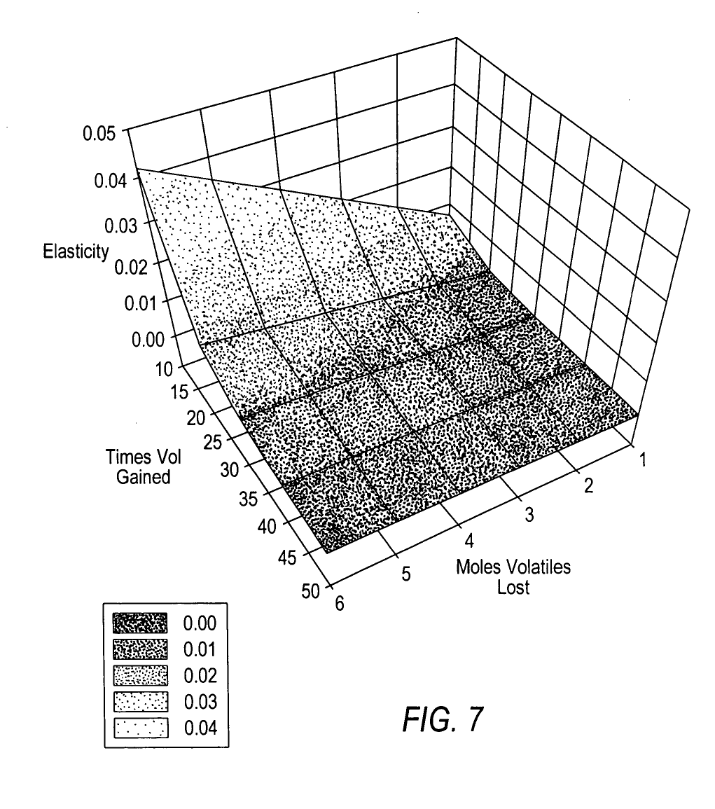

The stress-strain relationship provides the elastic modulus according to the following equation:
K=RT(n/V)/[(V−Vₒ)/(V_{c}+V₀)] [17],
and if Vₒ is 0, the equation may be simplified to the following equation:
V=\sqrt{(nRTV_{c})/K} [18],
or
K=RT(n/V)/(V/V_{c}) [19],
where V_{c} is 0.7. To determine the maximum increase in volume (the change in V at any given temperature), n must be determined. The value of K may be determined experimentally using tensile strength testing equipment or by measuring the volume increase at a given known value for n. The relationship between the percent volume of V gained by a chitosan sample of known elasticity and moles of volatile material lost is shown in FIG. 7 and may be used to determine the amount of volatile anion that must be lost for a chitosan of a given elasticity to swell to the desired volume.

Fully deacylated chitosan has a formula weight of 161 g/mole. If acetic acid is used as the volatile acid (molecular weight 60.05 g/mole), succinic acid is used as the non-volatile acid, and the elasticity/RT is 0.002, then 273.82 g glacial acetic acid, 70.86 g succinic acid, and 929.13 g 100% deacetylated chitosan would be required to absorb 40 times its weight in 0.15 M saline.

The calculations are as follows:
If K/RT=0.002 and a 40 times pickup is desired, then
0.002=(n/40)/(40/0.7)=4.56 moles volatile acid lost/kg solids,
4.56 mole×161 g/mole=734.16 g chitosan, and
1000 g solids−734.16 g chitosan=265.84 g of a mix of chitosan and a non-volatile acid (succinic) is needed to make 1000 g solids.

Since chitosan has a molecular weight of 161 g/mole and succinic acid has an equivalent weight of 59.04 (molecular weight 118.08 g/mole), the fraction of succinic acid in the 265.8 g mixture is calculated as follows:
(59.04 g/mole)/[(161 g/mole)+(59.04 g/mol)]=0.2683, and the fraction of chitosan is calculated as follows:
(161 g/mol)/[(161 g/mol)+(59.04 g/mol)]=0.7316.
These fractions multiplied by the required total amount of chitosan+succinic acid (265.84 g) gives 71.32 g succinic acid (1.208 equivalents) and 194.1 g chitosan (1.208 equivalents). Thus the total mix of the composition is:
734.16 g+194.97 g=929.13 g chitosan (5.77 equivalents),
70.86 g succinic acid (1.21 equivalents),
273.82 g acetic acid (4.56 equivalents),
   wherein the combined succinic and acetic acid is equal to 5.77 equivalents of acid which is enough to dissolve the chitosan. After the acetic acid is removed, the weight of the chitosan and succinic acid is 1000 g.

The volume increase in the pads pick-up can be determined by conducting tensile tests to obtain E. The moles of volatile acids to be removed may also be calculated. This will give a composition of matter as the % chitosan, % non-volatile acid, % moisture (if any), and the elastic modulus are known.

The maximum amount of volatile organic acid may be determined as follows:

For 1000 g of fully deacylated chitosan (6.21 mol) to be solubilized, 6.21 mole equivalent acid must be used. For acetic acid, this is ((6.21 mole)×(60.05 g/mole))=372.91 g. If a mixture of volatile and non-volatile organic acid is used, then less than one mole equivalent of volatile organic acid must be used.

### Example 17

Effect of chitosan succinate-acetate on absorption of saline, serum and blood and on coagulation of blood. Samples of chitosan A, shown in Tables 13-16, were tested for their effect on the coagulation of heparinized rabbit blood and absorption of saline, fetal calf serum, and heparinized blood. Prior to the preparation of the succinate-acetate chitosan pads, samples 2B2-1A, 2B2-2A3, 2B2-2A4, 2B-1A, 2B-2A, 2D-1A and 2D-2A were depolymerized by adding 0.118, 0.118, 0.118, 0.35, 0.35, 0.592, and 0.592 moles H₂O₂/moles of chitosan, respectively, adjusting the pH to approximately 10 for each sample, heating the samples to 80° C., washing the samples with alcohol, and drying the samples at approximately 60° C. Viscosity of samples 2A1-A, 2B2-1A, 2B2-1A, 2B-1A, 2D-1A, SQU2-1A was measured as 2.7 cps, 1.34 cps, 1.07 cps, 0.92 cps and 86.1 cps, respectively, with a Brookfield viscometer.

Chitosan succinate-acetate solutions were prepared by dissolving the chitosan or depolymerized chitosan in a mixture of succinic acid, acetic acid, and water according to mass amounts reported in Table 13, wherein a typical mole ratio of succinic acid to chitosan was 0.3038. These solutions were then freeze-dried in a Petri dish, placed in a 60° C. oven for 144 hrs, and then placed in a dessicator until testing. Table 14 reports the moles of chitosan, succinic acid, and acetic acid remaining in the pad after heating. The moles of acetic acid lost were calculated and additionally reported in Table 14.

One inch discs were then cut and used as substrates for the various absorption tests by placing the samples in a fixture designed such that heparinized rabbit blood released via a tube from a reservoir held eight inches above the chitosan disc entered the disc from its base The time to completely saturate the tared pad was then measured. The amount of blood absorbed by the saturated pad was then determined as well as the amount of blood absorbed per gram of dry pad (see Table 15). Analogous tests were also conducted to determine the absorption of fetal calf serum and 0.15 M saline.

TABLE 13
Quantities of chitosan, water, succinic acid and
acetic acid used in the preparation of chitosan
succinate-acetate pads.

| | Amount of | Amount of | Amount of | Amount of |
|---|---|---|---|---|
| | chitosan | water | succinic | acetic |
| | solids | used | acid used | acid |
| Sample | used (g) | (g) | (g) | used (g) |
| 2A1-A | 0.7011 | 70.0 | 0.1496 | 0.1 |
| 2A2-A | 0.7009 | 70.0* | 0.1472 | 0.1 |
| 2B2-1A | 0.7010 | 70.0 | 0.1500 | 0.1 |
| 2B2-2A3 | 0.7014 | 70.0* | 0.1473 | 0.1 |
| 2B2-2A4 | 0.7014 | 70.0* | 0.1473 | 0.1 |
| 2B-1A | 0.6993 | 70.0 | 0.1473 | 0.1 |
| 2B-2A | 0.7007 | 70.0* | 0.1513 | 0.1 |
| 2D-1A | 0.6988 | 70.0 | 0.1498 | 0.1 |
| 2D-2A | 0.7013 | 70.0* | 0.1470 | 0.1 |
| SQU2-1A | 0.7013 | 70.0 | 0.1902 | 0.1 |
| SQU2-2A | 0.7049 | 70.0* | 0.1926 | 0.1 |

*Samples were prepared with 0.1% solution of 9-N-9 detergent.

TABLE 14
Molar amounts of chitosan, succinic acid, acetic
acid remaining in chitosan succinate-acetate pads.

| | Moles | Moles | Moles | |
|---|---|---|---|---|
| | chitosan | succinic | acetic | Moles |
| | per kg | acid per | acid per | of |
| | solid | kg solid | kg solid | acetic |
| | (after | (after | (after | acid |
| Sample | heating | heating) | heating) | lost |
| 2A1-A | 4.74 | 2.75 | 0.44 | 1.55 |
| 2A2-A^{a} | 4.70 | 1.42 | 0.62 | 2.66 |
| 2B2-1A | 4.71 | 1.43 | 0.54 | 2.74 |
| 2B2-2A3^{a} | 4.81 | 1.46 | 0.19 | 3.16 |
| 2B2-2A4^{a} | | | | |
| 2B-1A | 3.81 | 1.3 | 0.54 | 1.97 |
| 2B-2A^{a} | | | | |
| 2D-1A | 4.64 | 1.43 | 0.66 | 2.55 |
| 2D-2A^{a} | 4.83 | 1.46 | 0.07 | 3.3 |
| SQU2-1A | | | | |
| SQU2-2A^{a} | 4.48 | 1.73 | 0.70 | 2.05 |

TABLE 15
Absorption studies of 0.15 M saline, fetal calf
serum and heparinized rabbit blood with chitosan
succinate-acetate pads.

| | Moles of | | | Absorption^{a} of |
|---|---|---|---|---|
| | acetic | Absorption^{a} | Absorption^{a} | heparinized |
| | acid | of 0.15 M | of fetal | rabbit |
| Sample | lost | saline | calf serum | blood |
| 2A1-A | 1.55 | 79.3 | 61.8 | |
| 2A2-Aa | 2.66 | 72.2 | 44.5 | |
| 2B2-1A | 2.74 | 50.97 | 48.8 | |
| 2B2-2A3a | 3.16 | | | 14.6 |
| 2B2-2A4a | | 49.2 | 36.1 | 23.7 |
| 2B-1A | 1.97 | | 39.1 | 7.3 |
| 2B-2Aa | | | 27.6 | |
| 2D-1A | 2.55 | | | |
| 2D-2Aa | 3.3 | | 23.6 | |
| SQU2-1A | | 117.2 | 62.1 | 35.0 |
| SQU2-2Aa | 2.05 | 94.0 | 64.2 | 27.5 |

^{a}Absorption = weight % of grams saturated pad/grams of dried pad.

Test tube coagulation tests were conducted using 5 mL of heparinized rabbit blood placed in a tube with 5 mL of a 0.2% solution of the chitosan succinate-acetate samples. The tubes were gently mixed until coagulum formed and the fluid had gelled. The observations made are reported in Table 16.

TABLE 16
Observations and coagulation/gelling time
of chitosan succinate-acetate in heparinized
rabbit blood.

| | | Formulation | |
|---|---|---|---|
| | | of | |
| | | coagulant | Formation |
| | | in test | of gel in |
| | Pad | tube | test tube |
| Sample | absorption | (min) | (min) |
| 2A1-A | instantaneous | | |
| 2A2-A^{a} | | | |
| 2B2-1A | 20 seconds | 8 | 12 |
| 2B2-2A3^{a} | | | |
| 2B2-2A4^{a} | | | |
| 2B-1A | Dissolved | 7.5 | 19 |
| 2B-2A^{a} | no structure | | |
| 2D-1A | no structure | 14.5 | no gel |
| 2D-2A^{a} | no structure | | |
| SQU2-1A | 58 seconds | 7.5 | 10 |
| SQU2-2A^{a} | | | |

### Example 18

Effect of Chitosan Salt on Coagulation of Blood (Hemostasis). Previous experiments have shown that 5 mL of a 0.2% solution of chitosan salts of this invention will clot heparinized blood in 15 seconds.

By way of example, if a person suffers from a gunshot wound and loses 50 mL of blood before and during treatment with 10 grams of chitosan succinate-acetate powder that is shaken into the wound, the powder will need to dissolve to provide enough ionized chitosan to react with the negatively charged substances in the blood to cause hemostasis. To accomplish this, there are 0.01 grams of ionized chitosan contained in approximately 0.0073 grams of 100% deacetylated chitosan ions. This will clot approximately 5 grams (˜5 mL) of blood. Similarly, 0.073 grams of ionized chitosan will clot approximately 50 mL (˜50 g) of blood. This means that the chitosan powder must be soluble in the amount of 0.073 g/10 g or 7.3% to provide enough chitosan ions to stop the bleeding and 6.05 times the weight of the residual pad as pick-up.

Coagulation experiments were performed using crumbled pads (or powder). These pads were prepared from chitosan C solutions and SQU and SQT solutions. The results are reported in Table 17.

TABLE 17
Hemostasis studies of chitosan.

| | | Succinic | Acetic Acid | | X Weight |
|---|---|---|---|---|---|
| Chitosan | Weight | Acid Wt. | Wt. | Water | Pick-up |
| CgB1 | 3.0040 | 1.0609 | 0.8392 | 296 | Dissolves |
| CgA1 | 3.0028 | 1.0605 | 0.8392 | 296 | 13.9 |
| CgD4 | 3.0028 | 1.0570 | 0.3892 | 296 | Dissolves |
| SQU2-1A | 0.5003 | 0.905 | 0.0607 | 49.3693 | 19.6 |
| SQU2-A2 | 0.5003 | 0.0905 | 0.0607 | 49.3693 | 32.2 |
| SQU1-B2 | 0.5015 | 0.1124 | 0.0120 | 49.4006 | 25.9 |
| SQU2-B1 | 0.5009 | 0.1089 | 0.0117 | 49.4006 | 28.3 |
| SQTA-2 | 0.5008 | 0.0902 | 0.0606 | 49.3530 | 18.8 |
| Dual Pad* | | | | | 5.8 |

*Dual pad made from 4% chitosan CgFx/succinic/HOAc and Viet chitosan/HOAc2%.

### Example 19

Preparation of chitosan to stop femural arterial bleeding. First, a 100% deacetylated squid chitosan is ground to a 60-80 mesh. An 80% isopropyl alcohol bath is prepared and 0.125 to 0.250 mole of any one of the non-volatile acids described above is added. To this solution, any one of the volatile acids previously provided is added to make a total of 1 mole. One mole of the ground chitosan is then added and stirred until all of the acid has reacted. Thereafter, the reacted chitosan from the bath is drained and dried. Next, the dry chitosan in a 60-70° C. oven and is re-dried until the volatile acid is removed. This results in a fully deacetylated chitosan with enough acid to neutralize the glucosamine groups and provides the requisite number of positively charged sites to react with the blood cells to cause hemostasis and enough uncharged sites to cause swelling by blood fluids.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein, including the appended claims.

1. A substantially water-insoluble composition comprising α- or β-chitosan, a non-volatile organic acid and a residual amount of a volatile organic acid, wherein said chitosan forms a salt with a selected amount of said non-volatile organic acid.

2. A substantially water-insoluble composition comprising α- or β-chitosan, a non-volatile organic acid and a residual amount of a volatile organic acid, wherein said chitosan forms a salt with a selected amount of said non-volatile organic acid such that said composition absorbs a predetermined amount of a fluid selected from water, serum, blood, saline, and mixtures thereof.

3. The composition according to claim 1 or 2, wherein said chitosan has a weight-average molecular weight of between about 50,000 and about 2,000,000 and a degree of deacetylation of between about 60% and 100%.

4. The composition according to claim 1 or 2, wherein said non-volatile organic acid and said chitosan are present in said composition at a mole ratio of non-volatile acid/chitosan of between about 0.2 and about 0.99.

5. The composition according to claim 1 or 2, wherein said non-volatile acid is succinic acid.

6. The composition according to claim 1 or 2, wherein said volatile organic acid is present in said composition at a concentration of less than 2% by weight of total solids.

7. The composition according to claim 1 or 2, wherein said volatile organic acid is acetic acid.

8. The composition according to claim 1, wherein said composition functions as a hemostat.

9. An article of manufacture comprising the composition according to claim 1.

10. The article of manufacture according to claim 9, wherein said article is selected from an absorbent pad, a bandage, a diaper, and a feminine hygiene absorbent article.

11. The article of manufacture according to claim 10, wherein said article is in a form selected from a pad, a film, a sponge, a sheet, a flake, and a powder.

12. A method for making a substantially water-insoluble composition comprising chitosan and a non-volatile organic acid, said chitosan forming a chitosan salt with said non-volatile organic acid, said method comprising:
(a) mixing an amount of chitosan with an amount of organic acid and water to produce a dissolved chitosan salt mixture, wherein the ratio of moles organic acid/moles chitosan is one or greater, wherein said organic acid comprises a non-volatile organic acid and a volatile organic acid, and wherein the ratio of moles non-volatile organic acid/moles chitosan is less than one and the ratio of moles volatile organic acid/moles chitosan is less than one;
(b) freeze-drying the chitosan salt mixture, wherein a portion of the volatile organic acid is sublimed with the water; and
(c) reducing the amount of remaining volatile organic acid to obtain the substantially water-insoluble composition.

13. The method according to claim 12, wherein said substantially water-insoluble composition functions as a hemostat.

14. The method according to claim 12, wherein said reducing is accomplished by any one of solvent extraction, heating, vacuum drying, and air drying the chitosan salt mixture.

15. The method according to claim 12, wherein said non-volatile acid is selected from adipic acid, ascorbic acid, citric acid, fumaric acid, glutamic acid, iminodiacetic acid, itaconic acid, lactic acid, maleic acid, malic acid, nitriloacetic acid, 2-pyrrolidone-5-carboxysol, succinic acid, tartaric acid, and mixtures thereof.

16. The method according to claim 12, wherein said volatile acid is selected from acetic acid, acrylic acid, butyric acid, formic acid, propionic acid, pyruvic acid, and mixtures thereof.

17. The method according to claim 12, wherein said ratio of moles non-volatile organic acid/moles chitosan is between about 0.2 to about 0.99.

18. The method according to claim 12, wherein, in (c), said volatile organic acid is present in said composition at a concentration of less than 2% by weight of total solids.

19. The method according to claim 12, wherein the degree of deacetylation of said chitosan is at least 70%.

20. The method according to claim 12, wherein said chitosan has a weight-average molecular weight of between 50,000 and 2,000,000.

21. A method for treating a mammal having an open wound or bleeding site, comprising applying to said mammal a substantially water-insoluble composition comprising α- or β-chitosan and a non-volatile organic acid according to claim 1.
